(19) United States
(12) Patent Application Publication
(10) Pub. No.: US 2009/0098927 A1
(43) Pub. Date: Apr. 16, 2009

(54) Gaming Machine

(75) Inventors: Hiroyuki NISHIMURA, Tokyo (JP); Yoichi KATO, Tokyo (JP); Hiroki SAITO, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/249,510

(22) Filed: Oct. 10, 2008

(30) Foreign Application Priority Data
Oct. 12, 2007 (JP) 2007-266433

(51) Int. Cl. A63F 9/24; A63F 13/00

(52) U.S. Cl. 463/20; 463/26

(57) ABSTRACT

In a bonus game, a slot machine associates a bonus reel band made up of condor symbols and feather symbols to reel display portions. Thereafter, the slot machine accepts a selection operation made by the player to select one pay line. The slot machine displays the symbols in a variable fashion and stopped fashion based on the bonus reel band. The slot machine determines the bonus contents such as award of a MAJOR JACKPOT in accordance with the number of condor symbols displayed on the selected pay line in a stopped fashion. Then, the slot machine awards to the player a bonus having the contents thus determined.

### CROSS-REFERENCE TO RELATED APPLICATIONS

This application is based upon and claims a priority from the prior Japanese Patent Application No. 2007-266433 filed on Oct. 12, 2007, the entire contents of which are incorporated herein by reference.

### BACKGROUND

1. Field

The preset invention relates to a gaming machine that displays symbols in a variable fashion and stopped fashion based on a symbol row. More particularly, it relates to a gaming machine that displays symbols in a variable fashion and stopped fashion based on a symbol row, even in a special game which is awarded as a result of a normal game.

2. Description of Related Art

Conventionally, there are known gaming machines that display symbols in a variable fashion and stopped fashion based on a symbol row including a plurality of symbols arranged in an array (for instance, including mechanical reels or video reels). In these gaming machines, a special game is awarded if predetermined conditions are satisfied (for instance, the gaming machine disclosed in the specification of U.S. Pat. No. 6,517,433).

In these gaming machines, various types of special games are adopted. For instance, the gaming machine disclosed in the specification of the U.S. Pat. No. 6,517,433 executes a game wherein a payout is directly obtained by selecting a choice image displayed on a display, or a so-called free game, as a special game.

Here, in a free game awarded as a special game, symbols are displayed in a variable fashion and stopped fashion based on a symbol row. The player can thus obtain a payout without consuming any gaming values. However, in executing the free game, the gaming machine described above displays symbols in a variable fashion and stopped fashion using the same symbol row all the time. In general, during execution of the free game, the player cannot get involved in the free game. More specifically, the player could observe the progress of the free game only vaguely.

Specifically, as the free game progresses, symbols are always displayed in a variable fashion and stopped fashion based on the same symbol row. The player cannot get involved in the game. Accordingly, the free game in such a gaming machine may become monotonous.

The present invention has been worked out in view of the above-described problems and relates to a gaming machine which displays symbols in a variable display and stopped display based on a symbol row, even in a special game. An object of the present invention is to provide a gaming machine which can offer novel amusement to the player, while preventing the special game from becoming monotonous.

### SUMMARY

Therefore, in order to achieve the object, according to a first aspect of the present invention, there is provided a gaming machine having: a display that displays: a plurality of symbol display areas wherein plural types of symbols including a first symbol to which a high payout award is associated are displayed in a variable fashion, and one symbol is displayed in each of the plurality of symbol display areas in a stopped fashion; and symbols in a variable fashion and stopped fashion per a symbol row on which plural types of symbols including the first symbol are arranged; and a processor that executes processes as follows: (a) a process of executing a normal game wherein symbols are displayed on the display in a variable fashion and stopped fashion, based on the symbol row; (b) a process of accepting a selection operation of selecting one pay line from a plurality of types of pay lines which are defined by the plurality of symbol display areas, if a game result of the normal game satisfies a predetermined condition; (c) a process of starting a special game and displaying the symbols in a variable fashion and stopped fashion, on condition one pay line has been selected; (d) a process of determining contents of one high payout from a plurality of high payouts having different contents, in accordance with the number of the first symbols displayed in a stopped fashion on symbol display areas making up the selected pay line; and (e) a process of awarding said one high payout thus determined as a prize with respect to the special game.

According to this gaming machine, a special game is executed if a game result of a normal game satisfies a predetermined condition. Upon executing the special game, the gaming machine accepts selection of a pay line. Accordingly, the gaming machine recognizes involvement of the player in the special game by allowing the player to select the pay line. The gaming machine can thus offer novel amusement to the player with respect to the special game. The gaming machine determines the content of one high payout from among a plurality of high payouts with different contents based on the number of the first symbol stopped and displayed on the selected pay line. As a result, the player can clearly and easily grasp the presence or absence of a high payout and the contents of the high payout by looking at the pay line that he/she selected on the display. The contents of the high payout to be awarded differ in accordance with the number of first symbols which are displayed in a stopped fashion on the selected pay line. Accordingly, the gaming machine offers novel amusement to the player who plays the special game by raising the sense of expectancy with respect to the contents of the high payout in the special game.

According to one or more aspects of the present invention, there is provided a gaming machine having: a display that displays: a plurality of symbol display areas wherein plural types of symbols including a first symbol to which a progressive payout award is associated are displayed in a variable fashion, and one symbol is displayed in each of the plurality of the symbol display areas in a stopped fashion; and symbols in a variable fashion and stopped fashion per a symbol row on which plural types of symbols including the first symbol are arranged; and a processor that executes processes as follows: (a) a process of executing a normal game wherein symbols are displayed on the display in a variable fashion and stopped fashion, based on the symbol row; (b) a process of accepting a selection operation of selecting one pay line from a plurality of types of pay lines which are defined by the plurality of symbol display areas, if a game result of the normal game satisfies a predetermined condition; (c) a process of starting a special game and displaying the symbols in a variable fashion and stopped fashion, on condition one pay line has been selected; (d) a process of determining one progressive payout amount from a plurality of differing progressive payout amounts which are stored in a memory, in accordance with the number of the first symbols displayed in a stopped fashion on symbol display areas making up the selected pay line; and (e) a process of acquiring information with respect to the progressive payout amount thus determined from the memory and awarding a progressive payout amount based on the information thus acquired as a prize with respect to the special game.

Similarly with the gaming machine described above, this gaming machine accepts selection of the pay line at the start of the special game. According to this gaming machine, the player can get involved in the special game. Further, the player can enjoy novel amusement with respect to the special game. In the special game, the presence or absence of award of a progressive payout amount is determined based on the number of first symbols displayed on the selected pay line. Accordingly, the player can clearly and easily grasp the award of a progressive payout amount and the contents of the progressive payout amount by looking at the pay line that he/she selected on the display. The progressive payout amount to be awarded changes in accordance with the number of first symbols displayed on the selected pay line in a stopped fashion. Accordingly, the gaming machine can offer novel amusement to the player who plays the special game by raising the sense of expectancy with respect to the contents of the progressive payout amount in the special game. The progressive payout amount is an extremely high payout as compared to the payout which is normally awarded. Thus, the gaming machine can raise the sense of expectancy of the player that hopes for a high payout award.

According to one or more aspects of the present invention, there is provided a gaming machine having: a display that displays: a plurality of symbol display areas wherein plural types of symbols including a first symbol to which a progressive payout award is associated are displayed in a variable fashion, and one symbol is displayed in each of the plurality of the symbol display areas in a stopped fashion; and symbols in a variable fashion and stopped fashion per a video reel made up of symbol row on which plural types of symbols including the first symbol are arranged; and a processor that executes processes as follows: (a) a process of executing a normal game wherein symbols are displayed on the display in a variable fashion and stopped fashion, based on the video reels; (b) a process of accepting a selection operation of selecting one pay line from a plurality of types of pay lines which are defined by the plurality of symbol display areas, if a game result of the normal game satisfies a predetermined condition; (c) a process of starting a special game and displaying the symbols in a variable fashion and stopped fashion, on condition one pay line has been selected; (d) a process of determining one progressive payout amount from a plurality of differing progressive payout amounts, in accordance with the number of the first symbols displayed in a stopped fashion on symbol display areas making up the selected pay line; and (e) a process of acquiring information with respect to the progressive payout amount thus determined from a memory and awarding the progressive payout amount based on the acquired information as a prize with respect to the special game.

As is the case with the above-described gaming machine, this gaming machine accepts selection of the pay line at the start of the special game. According to this gaming machine, the player can get involved in the special game. Further, the player can enjoy novel amusement with respect to the special game. In the special game, the presence or absence of a progressive payout amount award is determined based on the number of first symbols displayed on the selected pay line. Accordingly, the player can clearly and easily grasp the award of the progressive payout amount and the contents of the progressive payout amount by looking at the pay line that he/she selected on the display. The progressive payout amount to be awarded differs in accordance with the number of first symbols that are displayed on the selected pay line in a stopped fashion. Accordingly, the gaming machine can offer novel amusement to the player who plays the special game by raising the sense of expectancy with respect to the contents of the progressive payout amount in the special game. Further, the progressive payout amount is an extremely high payout as compared to the payout which is normally awarded. Accordingly, the gaming machine can further increase the sense of expectancy of the player hoping for award of a high payout. The gaming machine uses video reels, making it possible to easily realize the above configuration.

### BRIEF DESCRIPTION OF THE DRAWINGS

FIG. 1 is a flow chart of a bonus game process program according to the present embodiment;

FIG. 2 is a perspective view showing an outer appearance of a slot machine;

FIG. 3 is an explanatory diagram showing a reel display portion of the slot machine;

FIG. 4 is an explanatory diagram showing a symbol display area of the slot machine;

FIG. 5 is a block diagram showing an internal configuration of the slot machine;

FIG. 6 is a block diagram showing an internal configuration of a sub-control board in the slot machine;

FIG. 7 is an explanatory diagram showing respective symbols constituting a reel band in the slot machine;

FIG. 8 is an explanatory diagram showing one portion of a normal reel band in the slot machine;

FIG. 9 is an explanatory diagram showing a variable display portion wherein symbols are displayed in a variable fashion;

FIG. 10 is an explanatory diagram showing a variable display portion wherein symbols are displayed in a stopped fashion;

FIG. 11 is an explanatory diagram showing a payout table of the slot machine according to the present embodiment;

FIG. 12 is a flow chart of a main control process program according to the present embodiment;

FIG. 13 is a flow chart of a main game process program according to the present embodiment;

FIG. 14 is an explanatory diagram showing a table including associations between code numbers and symbols in a normal reel band;

FIG. 15 is an explanatory diagram showing a table including associations between random numbers and code numbers;

FIG. 16 is a flow chart of a free game process program according to the present embodiment;

FIG. 17 is an explanatory diagram showing one portion of a bonus reel band in the slot machine;

FIG. 18 is a display example of a bonus game screen displayed in the variable display portion;

FIG. 19 is an explanatory diagram showing a table including associations between code numbers and symbols in a bonus reel band;

FIG. 20 is an explanatory diagram showing a bonus content determination table according to the present embodiment.

### DETAILED DESCRIPTION

Next, a detailed description will be given with respect to embodiments relating to a gaming machine according to the present invention as applied to a slot machine 1, while referring to the accompanying drawings.

A slot machine according to the present embodiment has an image display device such as a liquid crystal display or the like. The slot machine advances a game by displaying images of various types of symbols on the image display device. In other words, the slot machine is a so-called video slot machine.

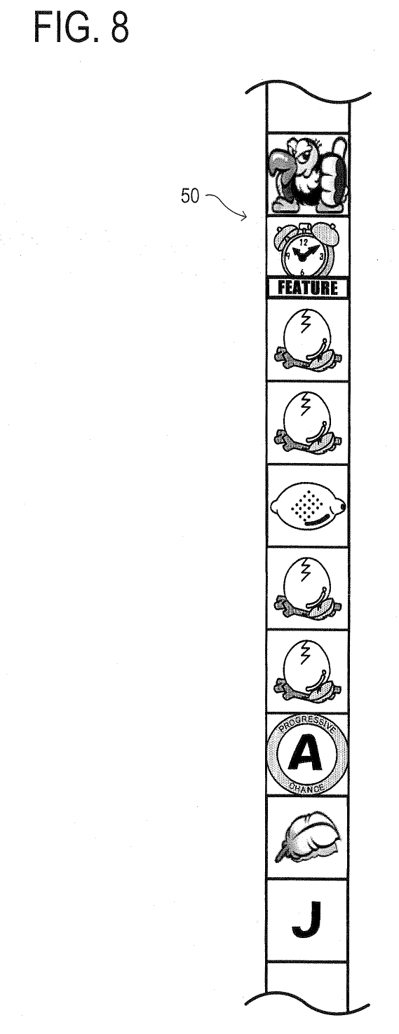

The slot machine 1 according to the present embodiment displays symbols in a variable fashion and stopped fashion by using the normal reel bands 50 (refer to FIG. 8), on a first reel display portion 101 through a fifth reel display portion 105. The slot machine 1 awards a payout in accordance with the number of the same kind of symbols which are displayed on the variable display portion 3B in a stopped fashion. Here, if a predetermined number of (in the present embodiment, three) or more bonus “10” symbol 45P through bonus ace symbol 45U are displayed on the variable display portion 3B in a stopped fashion, the slot machine 1 awards a bonus game (S20, S26).

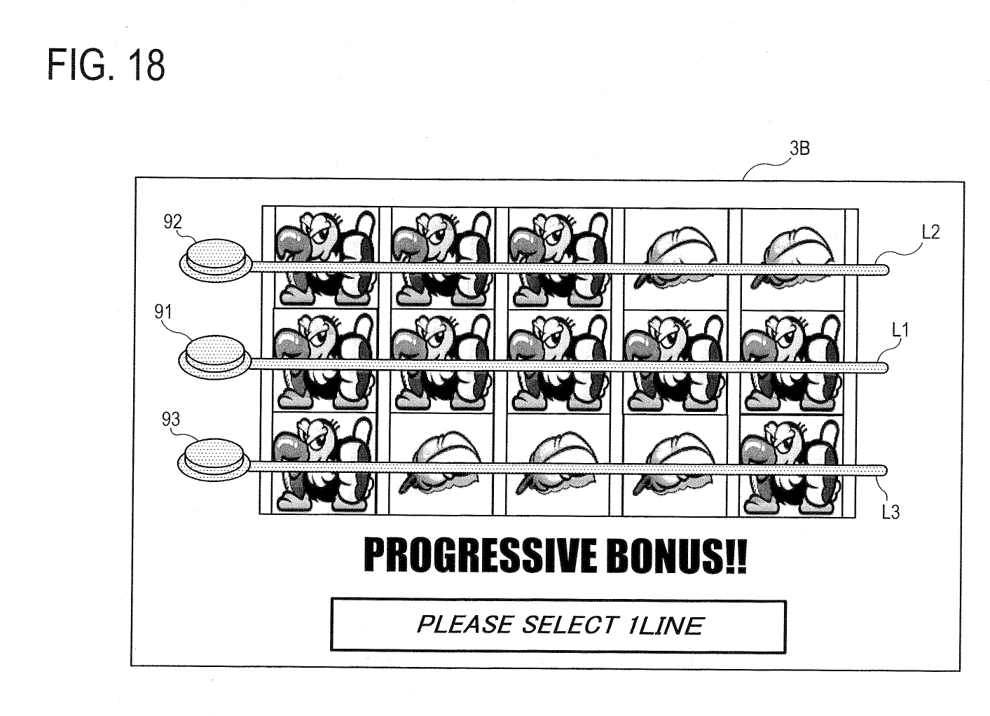

In the bonus game, a bonus game screen (refer to FIG. 18) is displayed on the variable display portion 3B. The slot machine 1 accepts a selection operation made by the player with respect to the first pay line selection image 91 through the third pay line selection image 93 (S32). Once one pay line is selected from amongst the first pay line L1 through the third pay line L3, the main CPU 42 displays the symbols on the reel display portions in a variable fashion and stopped fashion, based on the bonus reel band 55 including only condor symbols 45B and feather symbols 45C. Once the symbols are displayed in the reel display portions in a stopped fashion, the slot machine 1 determines the contents of the bonus (type of the progressive jackpot) in accordance with the number of condor symbols 45B which are displayed on the selected pay line in a stopped fashion (S36). The slot machine 1 then awards a bonus based on the contents thus determined (S37).

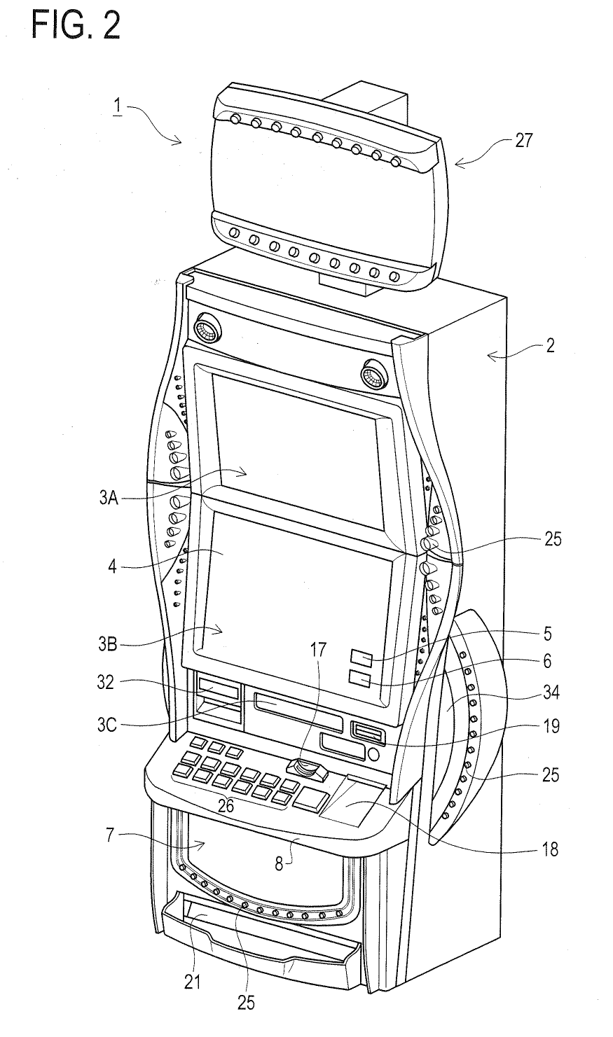

Next, the schematic configuration of the slot machine 1 according to the present embodiment will now be described in detail while referring to the accompanying drawings. FIG. 2 is a perspective view showing an outer appearance of the slot machine 1 according to the present embodiment.

The slot machine 1 according to the present embodiment is an upright-type slot machine which is installed in a gaming arcade such as a casino or the like. The outer aspect of the slot machine 1 as shown in FIG. 2 represents simply one example of the present invention. However, this outer aspect is not limited to this instance alone.

As shown in FIG. 2, the slot machine 1 has a cabinet 2. The cabinet 2 serves as housing portion for housing electrical or mechanical components. These electrical or mechanical components are used in execution of a predetermined game aspect.

The slot machine 1 has an upper display portion 3A, a variable display portion 3B and a lower display portion 3C provided at a front face of cabinet 2. The upper display portion 3A, the variable display portion 3B and the lower display portion 3C display various types of game information.

The upper display portion 3A is constituted of a liquid crystal panel and is arranged at an upper level of the cabinet 2. The upper display portion 3A displays effect images, payout tables and game rules for the game, etc.

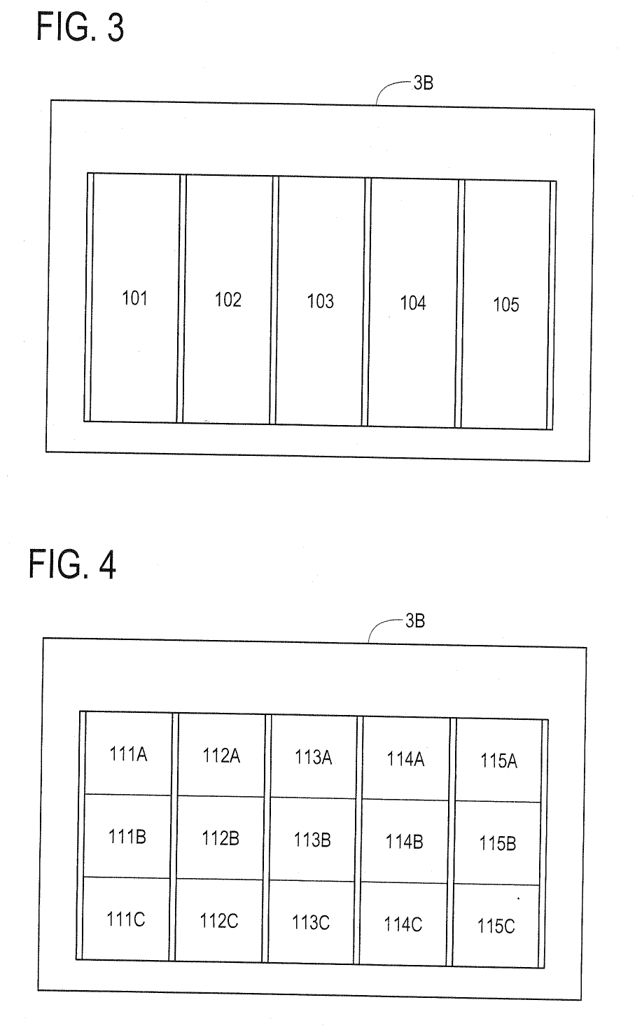

The variable display portion 3B is constituted of a liquid crystal panel which is arranged at a mid level of the cabinet 2. The variable display portion 3B has five reel display portions including a first reel display portion 101 through a fifth reel display portion 105 (refer to FIG. 3). The reel display portions serve to display symbol rows (specifically, a normal reel band 50, a first special reel band 50A and a second special reel band 50B) which are associated thereto in a variable fashion and stopped fashion. The first reel display portion 101 through the fifth reel display portion 105 each have three symbol display areas, respectively. More specifically, the first reel display portion 101 through the fifth reel display portion 105 each have symbol display areas 111A through 111C, 112A through 112C, 113A through 113C, 114A through 114C and 115A through 115C. Each symbol display area is adapted to display one symbol, respectively (refer to FIG. 4). In other words, the variable display portion 3D displays fifteen symbols in a 3×5 matrix. The number of reel display portions and the number of symbols displayed in one reel display portion may vary.

The variable display portion 3B has a touch panel 4 provided at a front face of its liquid crystal panel. The player can thus enter various types of commands by operating the touch panel 4. For instance, in a free game process (S18) as will be described later, the player selects a first choice image 91 and a second choice image 92 through the touch panel 4.

A payout amount display portion 5 and a credit amount display portion 6 are provided at a right lower portion of the variable display portion 3B. The display position to arrange the payout amount display portion 5 and the credit amount display portion 6 can be determined arbitrarily. A bet amount display portion for displaying the bet amount can also be provided in the variable display portion 3B. The payout amount display portion 5 displays a payout amount to be awarded to the player. The payout amount includes the payout amount which is granted if predetermined conditions are satisfied in the normal game, and an accumulated payout amount obtained in the free game. The credit amount display portion 6 displays the credit amount that the player currently possesses.

The lower display portion 3C is constituted of a liquid crystal panel. The lower display portion 3C is arranged at a lower level of the cabinet. The lower display portion 3C displays the number of points recorded in the card and the number of game points. In a case where the card is not inserted or when a card read failure occurs, a corresponding message is displayed on the lower display portion 3C.

A card reading portion 19 is provided at the periphery of the lower display portion 3C. The card reading portion 19 reads the information stored in the card that the player possesses.

As was described above, in the present embodiment, the upper display portion 3A, the variable display portion 3B and the lower display portion 3C are not limited to a liquid crystal display configuration. For instance, the respective display portions can be constituted using a CRT display, a plasma display, an LED display or other known display devices.

A lower panel 7 is provided at a lower side of the lower display portion 3C. This lower panel 7 is constituted of a plastic panel and is illuminated by a back light. The lower panel 7 includes a picture of a character relating to the slot machine 1, the designation of the slot machine and the like. The lower panel 7 can be constituted of a liquid crystal display, a CRT display, a plasma display, an LED display or other known display devices.

An operation table 8 is provided at a lower side of the variable display portion 3B. The operation table 8 has various types of operation buttons 26 (for instance, an exchange button, a cash out button, a help button, a BET button and a start button and the like). The operation table 8 has a coin insertion portion 17 and a bill insertion portion 18.

The position to arrange the respective types of operation buttons can be determined arbitrarily. As necessary, one portion of the respective operation buttons may be eliminated or buttons may be newly added or replaced.

A coin payout portion and a coin tray 21 are formed at a lower side of the cabinet 2. The coin payout portion serves to payout coins when the exchange button or the cash out button is operated. The coin tray 21 serves to receive coins that were paid out from the coin payout portion. The coin payout portion has a coin detecting portion provided therein. The coin detecting portion is constituted of a sensor or the like, and is adapted to detect the number of coins to be paid out from the coin payout portion.

A light emitting portion 25 is provided at the periphery of the cabinet 2 in the slot machine 1. This light emitting portion 25 illuminates in a predetermined illumination pattern in the event of a winning combination or during the free game. Further, a speaker 34 for audio output is provided at a side face of the cabinet 2. The position to arrange the light emitting portion 25 and the speaker 34 can be determined arbitrarily.

The slot machine 1 has a topper effect device 27 provided at the upper side of the cabinet 2 (refer to FIG. 2). The topper effect device 27 has a rectangular board shape and is arranged so as to be substantially parallel with the upper display portion 3A. The topper effect device 27 displays various types of information. The shape of the topper effect device 27 can be designed arbitrarily.

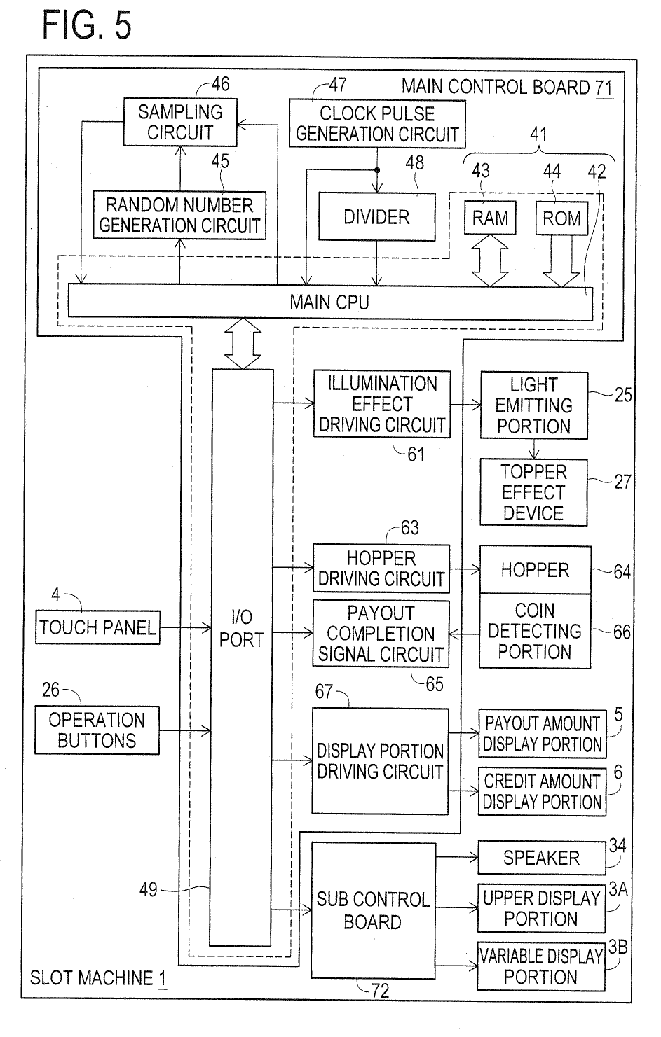

Next, the internal configuration of the slot machine 1 will be described while referring to the drawings. FIG. 5 is a block diagram showing an internal configuration of the entire slot machine 1. As shown in FIG. 5, the slot machine 1 has a main control board 71 including a controller 41, with the main control board 71 serving as a functional core. The slot machine 1 further includes a plurality of constituting elements. The main control board 71 has a controller 41, a random number generation circuit 45, a sampling circuit 46, a clock pulse generation circuit 47, a divider 48, an illumination effect driving circuit 61, a hopper driving circuit 63, a payout completion signal circuit 65 and a display portion driving circuit 67.

The controller 41 has a main CPU 42, a RAM 43 and a ROM 44. The main CPU 42 operates in accordance with the programs stored in the ROM 44 and performs signal input and output with respect to the other constituting elements through the I/O port 49. Specifically, the main CPU 42 controls the operation of the entire slot machine 1.

The RAM 43 stores data and programs to be used when the main CPU 42 is operating. For instance, the RAM 43 temporarily retains, after the game starts, the random number values which have been sampled by the sampling circuit 46. The RAM 43 stores code numbers corresponding to the first reel display portion 101 through the fifth reel display portion 105. To be more specific, these code numbers respectively correspond to the normal reel band 50, the first special reel band 50A and the second special reel band 50B equipped for each of the first reel display portion 101 through the fifth reel display portion 105.

The RAM 43 stores payout data with respect to a plurality of types of progressive jackpots. Specifically, the slot machine 1 has a “MAJOR JACKPOT” and a “MINOR JACKPOT” as two types of progressive jackpot. Specifically, once the player has placed the bet, the RAM 43 stores data contents which are updated by adding one portion of the bet to the current payout data.

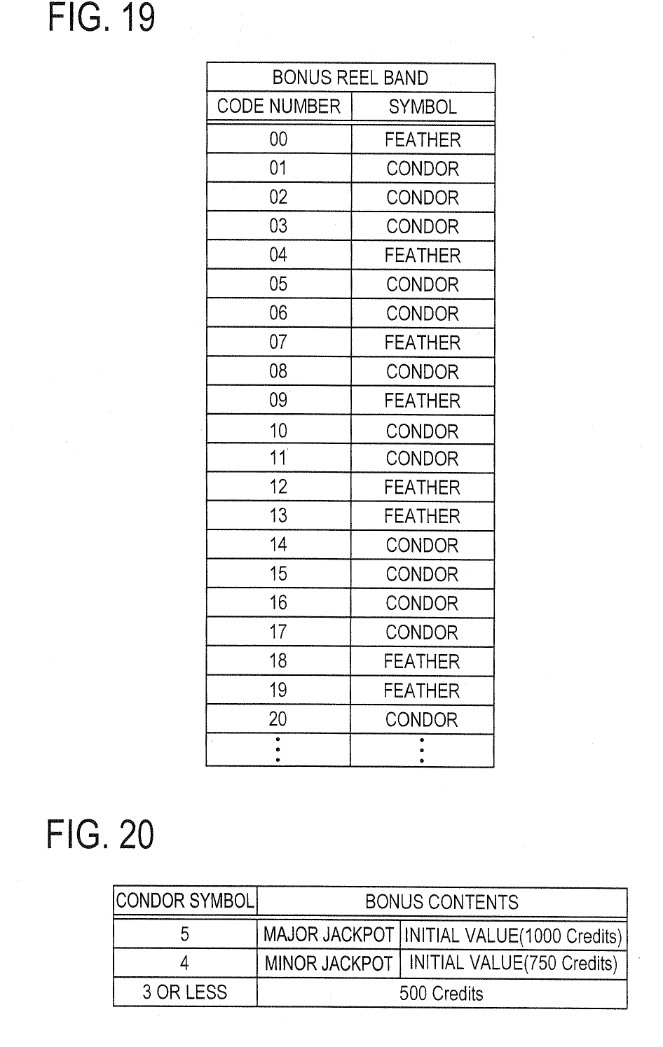

The “MAJOR JACKPOT” is a jackpot bonus wherein the initial value is “1000 credits”. In case the player wins this jackpot bonus is won, he/she will be awarded at least 1000 credits. If the payout data corresponding to the “MAJOR JACKPOT” reaches 1000 credits or more through accumulative addition, a payout of 1000 credits or more is awarded to the player based on the payout data (refer to FIG. 20).

The “MINOR JACKPOT” is a jackpot bonus wherein the initial value is “750 credits”. In case the player wins this jackpot bonus is won, he/she will be awarded at least 750 credits. If the payout data corresponding to the “MINOR JACKPOT” reaches 750 credits or more through accumulative addition, a payout of 750 credits or more is awarded to the player based on the payout data (refer to FIG. 20).

The ROM 44 stores various types of control programs to be executed by the main CPU 42 and permanent data. The programs stored in the ROM 44 include game programs and game system programs (hereinafter referred to as game programs or the like). Further, the game programs include lottery programs.

The lottery programs are executed upon determining the code numbers corresponding to symbols which are stopped at a central position in the respective reel display portions (specifically, symbol display areas 111B, 112B, 113B, 114B and 115B) of the variable display portion 3B.

This lottery program includes symbol weighing data. The symbol weighing data shows correspondence relationships between the respective code numbers and one or a plurality of random number values within a predetermined number value range. The probability of lottery with respect to each symbol on the reel band is set by associating one or a plurality of random number values to one code number. The random number values are drawn by lottery and symbols which are identified as final from the random number values are displayed in a predetermined area on the variable display portion 3B.

The random number generation circuit 45 operates in accordance with the commands from the main CPU 42 and generates random numbers within a fixed range. The sampling circuit 46 draws an arbitrary random number from the random numbers generated by the random number generation circuit 45 in response to a command from the main CPU 42. The sampling circuit 46 inputs the random number thus drawn to the main CPU 42. The clock pulse generation circuit 47 generates a reference clock for causing the main CPU 42 to operate. A divider 48 inputs a signal obtained by dividing the reference clock by a constant cycle to the main CPU 42.

The main control board 71 is connected to the touch panel 4. As was described above, the touch panel 4 is arranged at a front face of the variable display portion 3B and is adapted to identify a coordinate position of the portion that was touched by the player. Specifically, the touch panel 4 can determine the operation of the player (for instance, the portion that the player has touched, and in what direction the touched portion has moved) based on the coordinate position information thus identified. A signal in accordance with the determination result is then inputted to the main CPU 42 through the I/O port 49.

The main control board 71 is connected to the operation buttons 26 (the above-described start button, etc.) which serve to enter commands to execute a game, through the operation switch. Accordingly, a signal in accordance with a depression operation of the operation buttons 26 is inputted to the main CPU 42 through the I/O port 49.

The illumination effect driving circuit 61 outputs an effect signal in accordance with a command from the main CPU 42 and is used to control illumination effects performed by the light emitting portion 25 and the topper effect device 27. The topper effect device 27 is connected to the illumination effect driving circuit 61 through the light emitting portion 25.

The hopper driving circuit 63 drives the hopper 64 under the control of the main CPU 42. As a result, the hopper 64 carries out a predetermined operation to payout coins to the coin payout portion. The coin detecting portion 24 detects the number of coins that were paid out by the hopper 64 and then inputs coin amount value data showing the amount of coins that was detected to the payout completion signal circuit 65. The payout completion signal circuit 65 receives coin amount value data from the coin detecting portion 24. Then, when the received coin amount data has reached the set coin amount value, the payout completion signal circuit 65 inputs a signal that notifies completion of coin payout to the main CPU 42. The display portion driving circuit 67 controls the display operation of the respective display portions including the payout amount display portion 5 and the credit amount display portion 6 and the like.

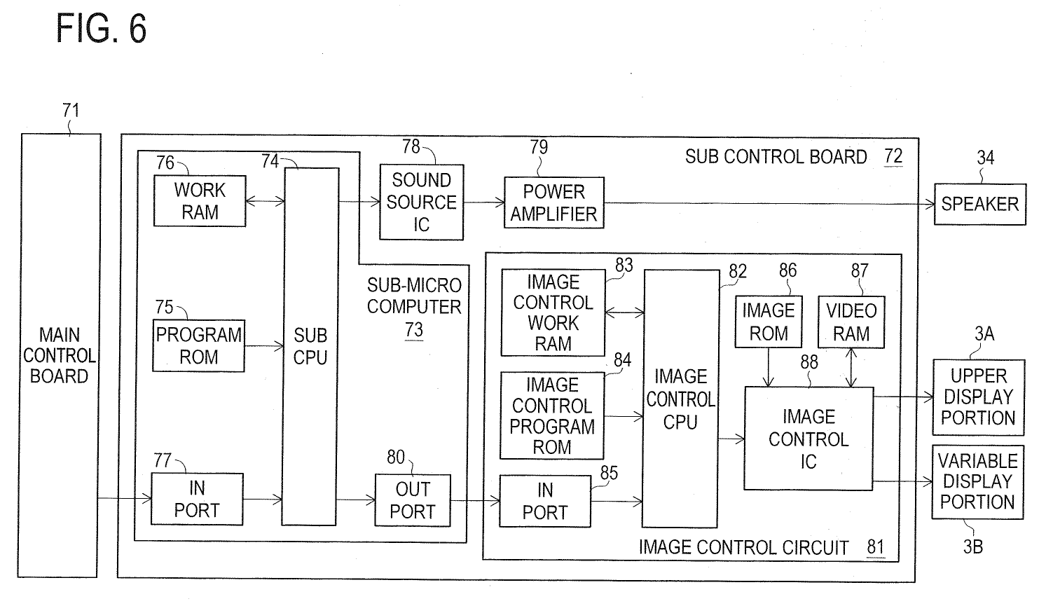

The main control board 71 is connected to the sub-control board 72. As shown in FIG. 6, the sub-control board 72 carries out display control of the respective display portions and output control of the audio outputted by the speaker 34 based on the commands inputted from the main control board 71. This sub-control board 72 is constituted on a separate circuit board from the circuit board that constitutes the main control board 71. The sub-control board 72 has a micro computer (hereinafter referred to as “sub-micro computer 73”) which is provided as a main constituting element. Then, the sub-control board 72 has a sound source IC 78, a power amplifier 79 and an image control circuit 81. The sound source IC 78 controls the audio which is outputted from the speaker 34. The power amplifier 79 functions as an amplifier with respect to the audio outputted from the speaker 34. The image control circuit 81 operates as a display control section for the upper display portion 3A and the variable display portion 3B.

The sub-micro computer 73 has a sub-CPU 74, a program ROM 75, a work RAM 76 and I/O ports 77 and 80. The sub-CPU 74 carries out a control operation in accordance with a control instruction transmitted from the main control board 71. The program ROM 75 stores a control program executed by the sub-CPU 74. The work RAM 76 is constituted as a temporary memory to be used in executing the control program in the sub CPU 74.

The sub-control board 72 does not have a clock pulse generation circuit, a divider, a random number generator and a sampling circuit, and executes random number sampling based on an operation program of the sub CPU 74.

The image control circuit 81 has an image control CPU 82, an image control work RAM 83, an image control program ROM 84, an image ROM 86, a video RAM 87 and an image control IC 88. The image control CPU 82 determines the image to be displayed on the upper display portion 3A and the variable display portion 3B based on the parameters set in the sub-micro computer 73 and the image control programs to be described later. For instance, the image control CPU 82 displays a payout table and a help screen on the upper display portion 3A. The image control CPU 82 serves to display symbols in a variable fashion and stopped fashion on the respective symbol display areas in the variable display portion 3B.

The image control program ROM 84 stores an image control program and various types of selection tables relating to display on the upper display portion 3A and the variable display portion 3B. The image control work RAM 83 functions as a temporary memory to be used in execution of the image control program in the image control CPU 82.

The image control IC 88 forms an image in accordance with the contents determined by the image control CPU 82 and then outputs the image thus formed to the upper display portion 3A and the variable display portion 3B. The image ROM 86 stores dot data for forming an image. The video RAM 87 functions as a temporary storage device to be used when an image is formed in the image control IC 88.

The internal configuration of the above-described slot machine 1 represents simply one example thereof and is not limited to the above-described configuration. For instance, the memory card and the PLD (Programmable Logic Device) can be constituted so as to be detachable. The memory card and the PLD can be constituted so as to allow readout of necessary information therefrom.

The slot machine 1 according to the present invention employs coins, bills or electronic valuable information (credits) corresponding to coins or bills, as gaming values. The gaming values applicable to this invention are not limited to these types. Medals, tokens, electronic money, tickets and the like, for instance can also be used as gaming values.

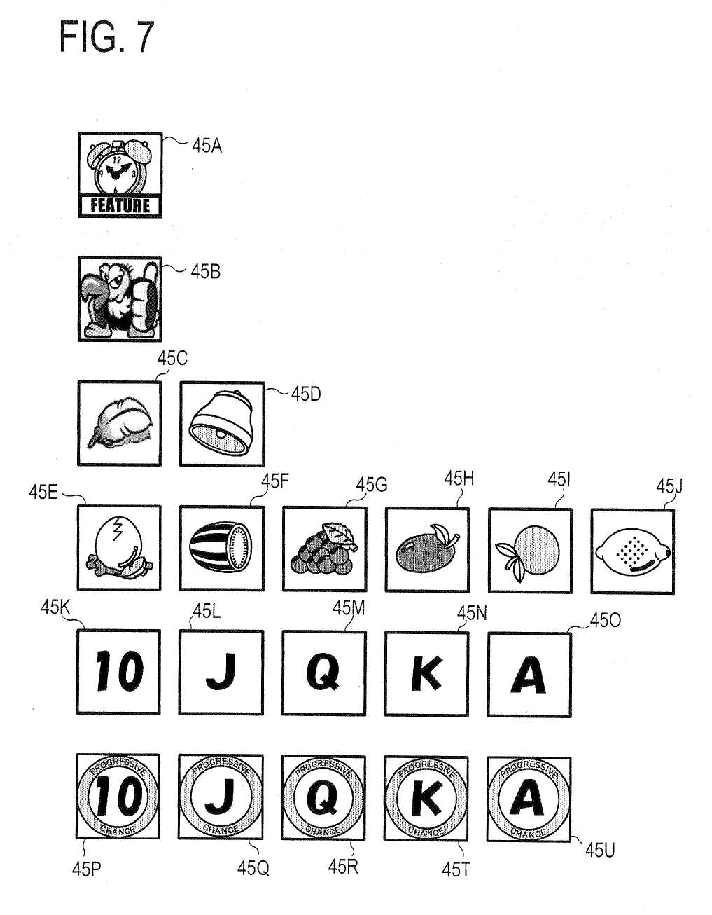

Next, the symbols which are drawn on the reel band and are variably displayed on the reel display portion will now be described in detail while referring to the accompanying drawings. FIG. 7 is a view showing one example of symbols drawn on the reel bands which are variably displayed on the respective reel display portions. FIG. 8 shows one portion of a normal reel band 50 which is variably displayed on each reel display portion.

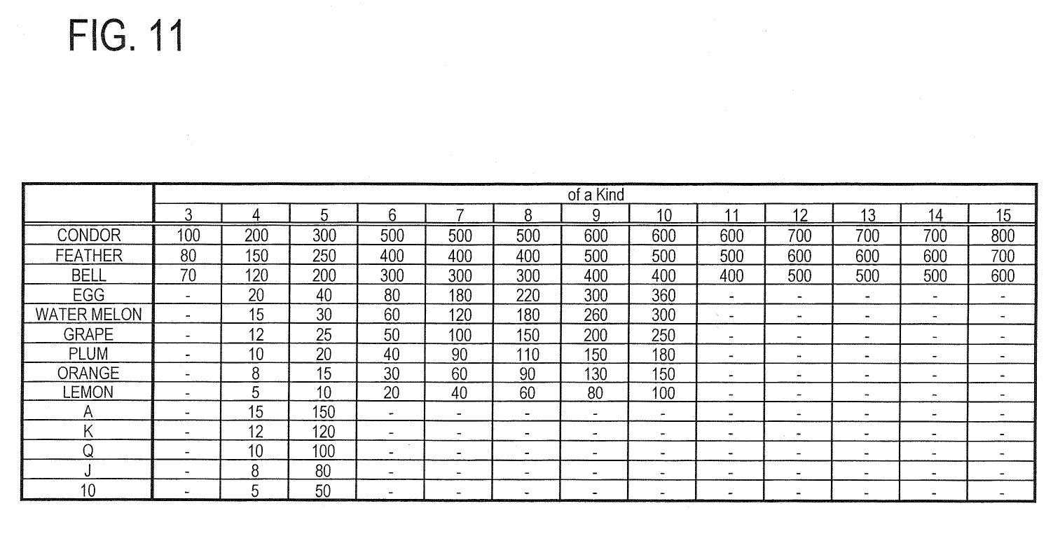

As shown in FIG. 7, the normal reel band 50 according to the present embodiment includes 20 types of symbols. A feature symbol 45A (FEATURE) serves as a free game trigger for shifting to a free game, as a feature game, as was described earlier. A condor symbol 45 (CONDOR) is associated to the highest payout in the slot machine 1 (refer to FIG. 11).

A feather symbol 45C (FEATHER) and a bell symbol 45D (BELL) are associated to the second highest payout following the condor symbol 45B (refer to FIG. 11).

An egg symbol 45E (EGG), a watermelon symbol 45F (WATERMELON), a grape symbol 45G (GRAPE), a plum symbol 45H (PLUM), an orange symbol 45I (ORANGE) and a lemon symbol 45J (LEMON) are associated to lower payouts than the condor symbol 45B, the feather symbol 45C and the bell symbol 45D. These six types of symbols differ from the above-described three types of high payout symbols. Specifically, a payout is awarded only in the event four to ten identical symbols from these six types of symbols are displayed in a stopped state (refer to FIG. 11).

“10” symbol 45K (10), jack symbol 45L (J), queen symbol 45M (Q), king symbol 45N (K), ace symbol 45O (A) are associated to an even smaller payout as compared to the above-described six types of symbols. Specifically, a payout is awarded only in the event four or five identical symbols from these five types of symbols are displayed in a stopped state (refer to FIG. 11).

A bonus “10” symbol 45P (BONUS-10), bonus jack symbol 45Q (BONUS-J), bonus queen symbol 45R (BONUS-Q), bonus king symbol 45T (BONUS-K) and bonus ace symbol 45U (BONUS-A) are handled as identical symbols with the above-described “10” symbol 45K through ACE symbol 45O.

The above-described bonus “10” symbol 45P through bonus ace symbol 45U function as bonus game triggers for shifting to the bonus game as will be described later.

If three or more of the five types of symbols are displayed on the variable display portion 3B in a stopped fashion (in case of the above-described five types of symbols, the type is irrelevant), the bonus game trigger is turned ON.

As shown in FIG. 8, the respective types of symbols as shown in FIG. 7 are drawn in a predetermined sequence in normal reel band 50. The normal reel band 50 as shown in FIG. 8 represents simply one example of a reel band. The sequence in which the symbols are drawn may also be determined arbitrarily. The number of symbols drawn on one normal reel 50 is determined arbitrarily, and kinds of to-be-drawn symbols may also be defined arbitrarily.

In the present embodiment, different normal reel bands 50 are associated to the first reel display portion 101 through the fifth reel display portion 105. Also, the same normal reel band 50 can be associated to the respective reel display portions.

Next, a game which is carried out in the slot machine 1 according to the present embodiment will now be described. In the game which is carried out in the slot machine 1, all the symbols are scatter symbols. Specifically, in the game according to the present embodiment, a prize is awarded based on the number of identical symbols displayed on the symbol display areas arranged in a 3×5 matrix in the variable display portion 3B (refer to FIG. 11).

As was described earlier, the bonus “10” symbol 45P through the BONUS ace symbol 45U are handled as “10” symbol 45K through ACE symbol 45O, respectively.

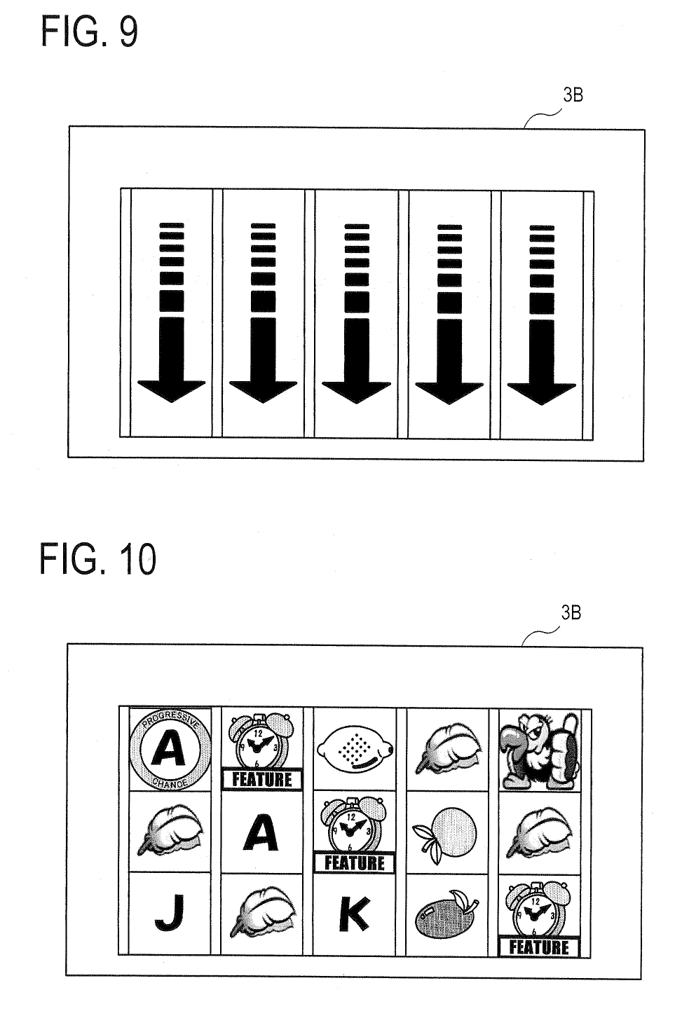

To start a game in the slot machine 1, the player operates the BET button to set the bet amount and then depresses the start button. As a result, the normal reel band 50 of each reel display portion starts spinning. In other words, the symbol row drawn on the normal reel band 5 is displayed in a scrolling fashion in a downward direction in each of the first reel display portion 101 through the fifth reel display portion 105 (refer to FIG. 9).

After a predetermined period has passed, the normal reel band 50 in each of the first reel display portion 101 through the fifth reel display portion 105 is displayed in a stopped fashion. Consequently, one portion of the symbol row constituting each normal reel band 50 (specifically, three symbols constituting the respective normal reel band 50) is displayed in a stopped fashion on each reel display portion. In other words, as shown in FIG. 10, one symbol is stopped and displayed respectively in each of the three symbol display areas constituting each reel display portion. As a result, the variable display portion 3B displays fifteen symbols in a stopped fashion (refer to FIG. 10).

As was described above, in the game according to the present embodiment, a winning combination is determined based on the number of identical symbols displayed on the variable display portion 3D and a prize corresponding to the winning combination is awarded. In the event of a winning combination, an amount obtained by multiplying the payout amount in accordance with the winning combination by the bet amount will be awarded to the player (refer to FIG. 11). This will be further described in more detail.

Next, the contents of the winning combination and the prize in the slot machine 1 according to the present embodiment will be described while referring to the drawings. FIG. 11 is an explanatory diagram showing a payout table according to the present embodiment.

As shown in FIG. 11, the payout table contains associations between the winning combination and prize to be awarded (specifically, the payout amount). The payout amount in the payout table shown in FIG. 11 shows the payout amount in the case the bet amount is “1”. Thus, if the bet amount is “1”, a payout amount as shown in FIG. 11 will be paid out. Also, if the bet amount is “2” or more, an amount obtained by multiplying the bet amount by the payout amounts as shown in FIG. 11 will be paid out.

For instance, if nine feather symbols 45C are displayed in the fifteen symbol display areas (refer to FIG. 4) in the variable display portion 3B, “an amount obtained by multiplying the bet amount by 500 credits” will be paid out to the player (refer to FIG. 11).

If four watermelon symbols 45F are displayed on the fifteen symbol display areas in the variable display portion 3D, “an amount obtained by multiplying the bet amount by 8 credits” will be paid out to the player (refer to FIG. 11). A payout amount is set for each winning combination in a similar manner, as shown in FIG. 11.

In the present embodiment, if three or more feature symbols 45A are displayed in the fifteen symbol display areas in the variable display portion 3B, a feature game is awarded to the player, in place of a payout amount. In the present embodiment, a so-called free game is awarded as feature game. Here, the free game can be executed without the need for the player to bet new credits.

In the present embodiment, if three or more bonus “10” symbol 45P through bonus ace symbol 45U are displayed in a stopped state, irrespective of their type, on the fifteen symbol display areas constituting the variable display portion 3B, a high payout such as a progressive jackpot is awarded to the player. The contents of the high payout to be awarded are determined in a bonus game process (S20).

If the symbols displayed in the fifteen symbol display areas of the variable display portion 3B do not correspond to any of the winning combinations shown in FIG. 11, the player loses. In case of losing, the player is not awarded a payout or prize.

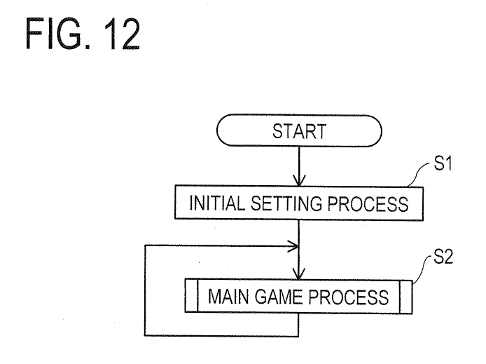

Next, the main control program which is executed in the slot machine 1 according to the present embodiment will be described in detail while referring to the accompanying drawings. FIG. 12 is a flow chart of a main control program.

When the power switch is turned on (upon power on), the main control board 71 and the sub-control board 72 are activated and the controller 41 executes an initial setting process (S1). In the initial setting process (S1), the main CPU 42 executes the BIOS stored in the ROM 44 and expands the compressed data incorporated in the BIOS in the RAM 43. In executing the BIOS that was expanded in the RAM 43, the main CPU 42 carries out a diagnosis and initialization of the different types of peripheral devices. Further, the main CPU 42 writes the game programs and the like from the ROM 44 into the RAM 43 to acquire payout rate setting data and country identification information. While executing the initial setting process (S1), the main CPU 42 also carries out an authentication process with respect to each program.

When the initial setting process (S1) ends, the main CPU 42 executes a main game process (S2). In this main game process (S2), the main CPU 42 sequentially reads the game programs and the like from the RAM 43 and executes these programs. The slot machine 1 according to the present embodiment carries out the game by executing this main game process (S2).

The main game process (S2) is repeatedly executed while power is being supplied to the slot machine 1.

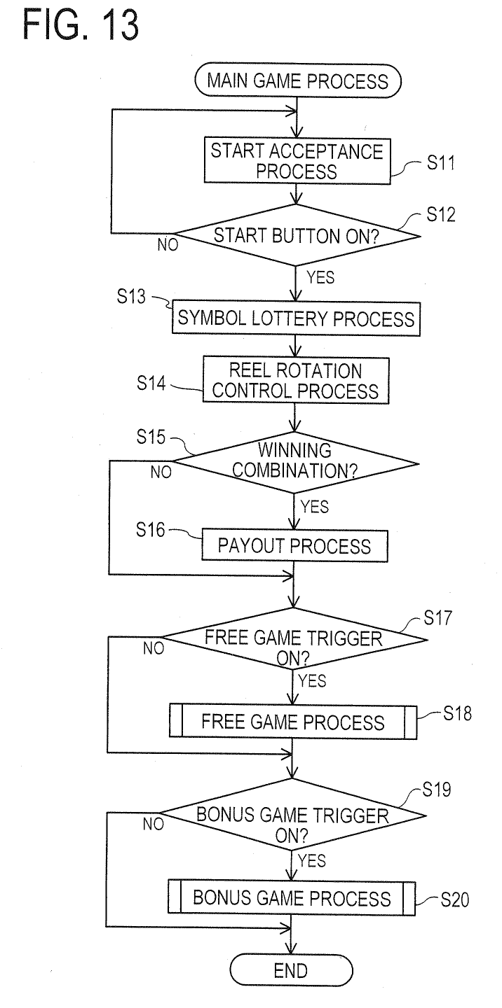

Next, the main game process program which is executed in the main game process (S2) will now be described while referring to the drawings. FIG. 13 is a flow chart of a main game process program to be executed in the slot machine 1 according to the present embodiment. The programs shown in the following flow chart are stored in the ROM 44 and RAM 43 provided in the slot machine 1 and are executed in the main CPU 42.

As shown in FIG. 13, the main CPU 42 first executes a start acceptance process (S11). In the start acceptance process (S11), the player inserts coins and carries out a betting operation using the BET button from amongst the operation buttons 26.

After shifting to step S12, the main CPU 42 determines whether the start button from amongst the operation buttons 26 has been depressed or not. The main CPU 42 determines the presence or absence of a depression with respect to the start button based on the presence or absence of a signal in response to a depression of the start button. If the start button has been depressed (S12: YES), the main CPU 42 subtracts the above bet amount set based on the betting operation from the credit amount that the player currently possesses. Then, the main CPU 42 stores the bet amount in the RAM 43 as bet information. At this time, the main CPU 42 adds one portion of the gaming values (credit) that were bet to the payout data with respect to the progressive jackpot which was stored in the RAM 43. Then, the main CPU 42 changes the contents of the payout data in the RAM 43.

Changing of the payout data with respect to the progressive jackpot is carried out with respect to each of a plurality of progressive jackpots (“MAJOR JACKPOT”, “MINOR JACKPOT”).

After subtraction of the credit amount and storing of the bet information have ended, the main CPU 42 shifts the flow to step S13. On the other hand, if the start button has not been depressed (S12: NO), the main CPU 42 returns the flow to the start acceptance process (S11). As a result, the player can carry out an operation to correct the bet amount, etc.

After shifting to step S13, the main CPU 42 executes a symbol lottery process. In this symbol lottery process (S13), the main CPU 42 executes the lottery program stored in the RAM 43, thereby sampling a random number value from a number value range within a predetermined random number value range. The main CPU 42 determines the symbols that are stopped at the central portion in each reel display portion (specifically, symbol display areas 111B, 112B, 113B, 114B and 115 B) based on the sampled random number value and table.

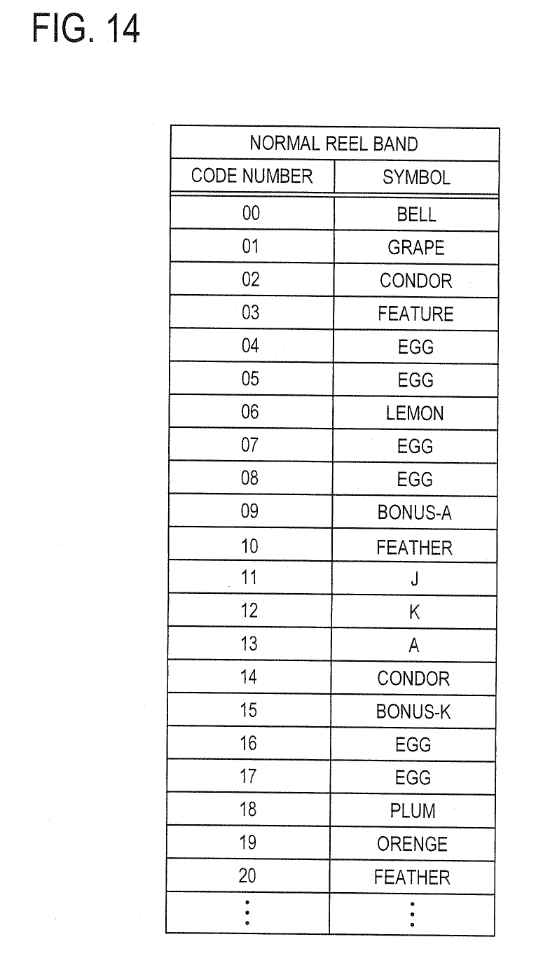

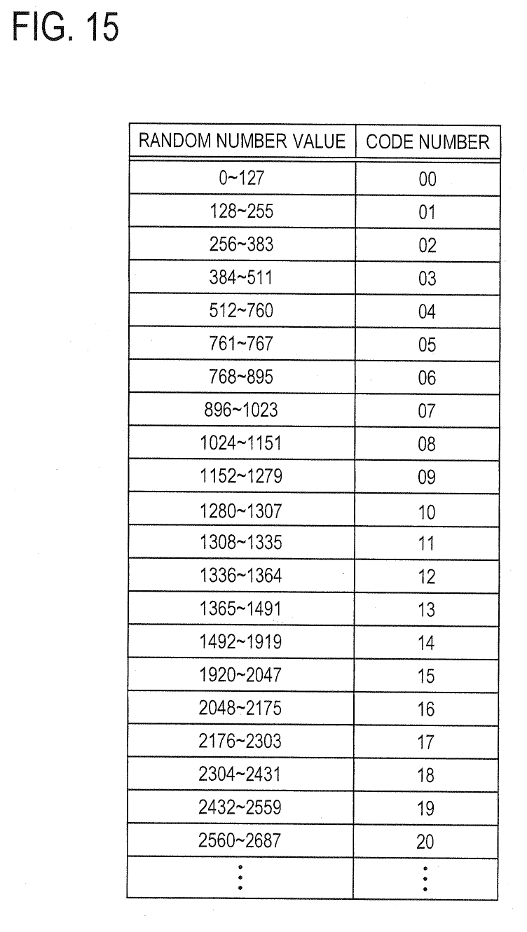

Here, a process using the random number value extracted in the symbol lottery process (S13) will now be described based on the drawings. FIG. 14 shows one example of a table including associations between the symbols drawn on any one reel band and the code numbers. FIG. 15 shows one example of a table including associations between the random number values and the code numbers.

As was described above, in the symbol lottery process (S13), the main CPU 42 executes a lottery program, thereby sampling a random number value from a predetermined random number range (for instance, 0 through 65535). Thereafter, the main CPU 42 determines the code numbers based on the sampled random number value and a table including associations between the random number values and the code numbers (refer to FIG. 15, for instance). After the code numbers have been determined, the main CPU 42 determines the symbols to be stopped in the central part of the reel display portion based on the code numbers and the table including associations between the symbols and code numbers (refer to FIG. 14).

For instance, when the normal reel band 50 shown in FIG. 14 is used with respect to the first reel display portion 101, if the random number value “1136” is sampled, the main CPU 42 determines the code number “08” based on the random number value “1136” and the table shown in FIG. 15. Then, the main CPU 42 determines the egg symbol 45E as the symbol which will be stopped and displayed on the symbol display area 111B based on the code number “08” and the table shown in FIG. 14.

The process using the random number value in the symbol lottery process (S13) is not limited to the instance of using the random number value, the table including associations between the random number values and the code numbers (refer to FIG. 15, for instance) and the table including associations between the symbols and the code numbers (refer to FIG. 14).

For instance, the sampled random number values and the symbols may be directly associated. Alternatively, the sampled random number values and the winning combinations can be directly associated to thereby allow determination of the symbol to be stopped using the table.

The processes in executing the main game process program following the symbol lottery process (S13) will next be described while referring back to FIG. 12.

After the symbol lottery process (S13) ends, the main CPU 42 executes a reel rotation control process (S14). In this reel rotation control process (S14), the main CPU 42 displays the normal reel band 50 on the first reel display portion 101 through the fifth reel display portion 105 in a variable fashion at a predetermined speed. Then, the main CPU 42 determines the effect pattern (pattern for image display on the variable display portion 3B and audio output from the speaker 34) with respect to a unit game. The main CPU 42 starts the effects based on the effect pattern thus determined by controlling the sub-control board 72, etc. Here, the unit game refers to a game executed in a sequence of processes from the start of variable display of each reel band until all the reel bands are stopped.

After the lapse of a predetermined period, the main CPU 42 stops the normal reel band 50 on the first reel display portion 101 through the fifth reel display portion 105 in a predetermined sequence. Thus, one symbol is stopped and displayed on each of the fifteen symbol display areas in the variable display portion 3B.

After the reel rotation control process (S14), the main CPU 42 judges whether or not the symbols displayed on the variable display portion 3B in a stopped fashion correspond to a winning combination (S15). More specifically, the main CPU 42 judges whether or not the symbols correspond to a winning combination based on the code numbers of each reel display portion stored in the RAM 43. If a winning combination is established (S15: YES), the main CPU 42 calculates a payout amount corresponding to the winning combination, based on the payout table (refer to FIG. 11). The main CPU 42 then shifts the flow to process S16. Alternatively, if no winning combination is established (S15: NO), the main CPU 42 shifts the process to S17.

After shifting to S16, the main CPU 42 executes a payout process. In this payout process (S16), the main CPU 42 pays out to the player a payout amount in accordance with the winning combination determined at S15. After the payout process (S16) ends, the main CPU 42 shifts the flow to process S17.

At the following process S17, the main CPU 42 judges whether the free game trigger has been established. More specifically, the main CPU 42 references the code numbers for the reel display portions that were stored in the RAM 43. Then, the CPU 42 judges whether or not “three or more feature symbols 45A are displayed in a stopped fashion on the fifteen symbol display areas constituting the variable display portion 3B”.

If three or more feature symbols 45A are displayed in a stopped fashion and the free game trigger is turned ON (S17: YES), the main CPU 42 shifts the flow to the free game process (S18). Alternatively, if the free game trigger has not been established (S17: NO), the main CPU 42 shifts the flow to process S19, as is.

After shifting to S18, the main CPU 42 executes a free game process. In the free game process (S18), the main CPU 42 executes a predetermined number of free games. The free game process (S18) will be described in detail later while referring to the drawings. Accordingly, description thereof at this point is omitted. After the end of the free game process (S18), the main CPU shifts the flow to process S19.

At S19, the main CPU 42 judges whether or not a bonus game trigger has been established. More specifically, the main CPU 42 references the code numbers for the reel display portions, which code numbers were stored in the RAM 43. Then, the main CPU 42 judges whether or not “3 or more bonus “10” symbol 45P through bonus ace symbol 45U are displayed in a stopped fashion on the fifteen symbol display areas constituting the variable display portion 3B”. If the bonus game trigger is turned ON (S19: YES), the main CPU 42 shifts the flow to the bonus game process (S20). Alternatively, if the bonus game trigger is not established (S19: NO), the main CPU 42 ends the main game process program, as is. As was described above, as soon as the main game process program ends, the program is re-executed.

At S20, the main CPU 42 executes a bonus game process. In this bonus game process (S20), the main CPU 42 determines the bonus contents (for instance, the type of the progressive jackpot to be awarded) based on the result of the bonus game. Then, the main CPU 42 awards a bonus having the determined contents. The bonus game process (S20) will be later described in detail while referring to the drawings. Thus, description thereof at this point will be omitted. Once the bonus game process (S20) ends, the main CPU 42 ends the main game process program as is. As was described earlier, as soon as the main game process program end, the program is re-executed.

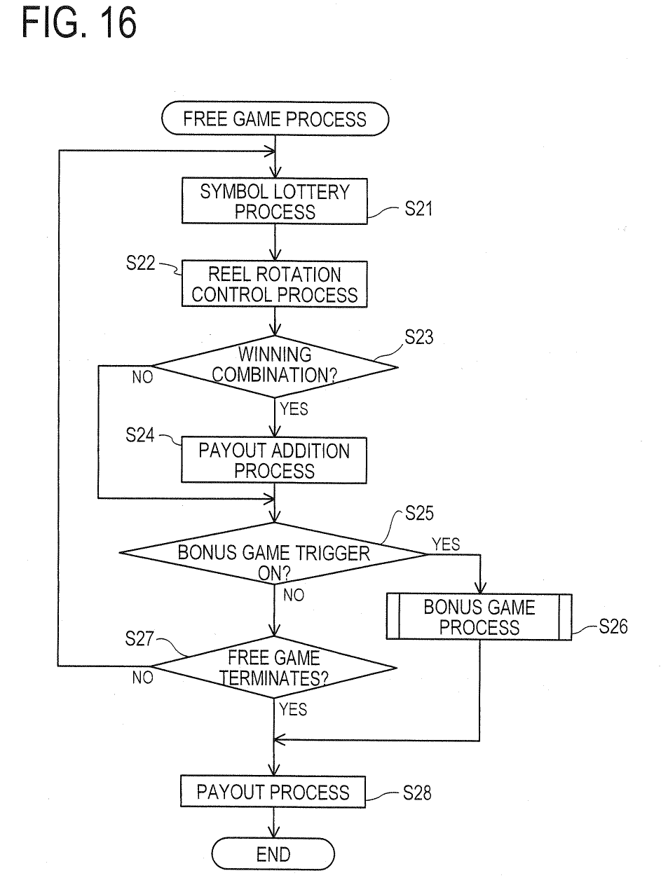

Next, the free game process program which is executed at S18 of the main game process program will be described in detail based on the drawings. FIG. 16 is a flow chart of a free game process program according to the present embodiment. The procedure of the free game is in principle the same as the normal game. The differences thereinbetween are that in the free game, game values (credits) corresponding to the bet amount are not consumed at the start of the game and that the game is automatically and successively executed without the need for the player to operate the operation button.

Once the free game trigger is established (S17: YES) and the flow shifts to the free game process (S18), the main CPU 42 first executes a symbol lottery process (S21). Next, the main CPU 42 executes a reel rotation control process (S22). The symbol lottery process (S21) and the reel rotation control process (S22) are similar to the above-described symbol lottery process (S13) and the reel rotation control process (S14). As the process contents of the symbol lottery process (S13) and the reel rotation control process (S14) have been described, description of the symbol lottery process (S21) and the reel rotation control process (S22) will be hereby omitted. After symbols are displayed on the variable display portion 3B in a stopped fashion in the reel rotation control process (S22), the main CPU 42 shifts the flow to process S23.

After shifting to S23, the main CPU 42 judges whether or not the symbols arranged on the variable display portion 3B correspond to a winning combination. The judgment process at S23 is in principle similar with the judgment process at S15 as was described earlier. Accordingly, a detailed description thereof is hereby omitted. If the winning combination is established (S23: YES), the main CPU 42 shifts the flow to S24. Alternatively, if no winning combination is established (S23: NO), the main CPU 42 shifts the flow to process S25.

At S24, the main CPU 42 executes a payout addition process. In this payout addition process (S24), the main CPU 42 sequentially adds the payout amount determined at S23 to the payout amount obtained in the free game process. The payout amount obtained in the payout addition process (S24) is paid out to the player in the payout process (S28) as will be described later.

Then, at S25, the main CPU 42 judges whether or not the bonus game trigger has been established. The judgment process at S25 is in principle similar with the judgment process at S19 as was described earlier. If the bonus game trigger is ON (S25: YES), the main CPU 42 shifts the flow to process S26. Alternatively, if the bonus game trigger is not established (S25: NO), the main CPU 42 shifts the flow to process S27.

At S26, the main CPU 42 executes the bonus game process. This bonus game process (S26) is similar with the bonus game process (S20) in the main game process program as described above. As the contents of this process have already been described, further description of the bonus game process (S26) is hereby omitted. Once the bonus game process (S26) ends, the main CPU 42 shifts the flow to process S28.

After shifting to S27, the main CPU 42 judges whether or not the completion condition for the free game is satisfied. Specifically, the main CPU 42 judges whether or not a predetermined number of free games have been executed. If the predetermined number of games have been carried out (S27: YES), the main CPU 42 shifts the flow to the payout process (S28). Alternatively, if a number of games corresponding to the free game have not yet been executed (S27: NO), the main CPU 42 reverts the flow to the symbol lottery process (S21). As a result, one free game is re-executed in the slot machine 1.

At S28, the main CPU 42 pays out to the player a payout amount obtained in the payout addition process (S25). After the payout amount ends, the main CPU 42 ends the free game process program. If the flow shifts to S28 after passing through the bonus game process (S26), a payout amount obtained in the free game prior to shifting to the bonus game is awarded to the player in this payout process (S28).

In this payout process (S28), the total payout amount thus obtained is paid out in once time when a predetermined number of free games have been carried out. However, the payout can be made in each free game.

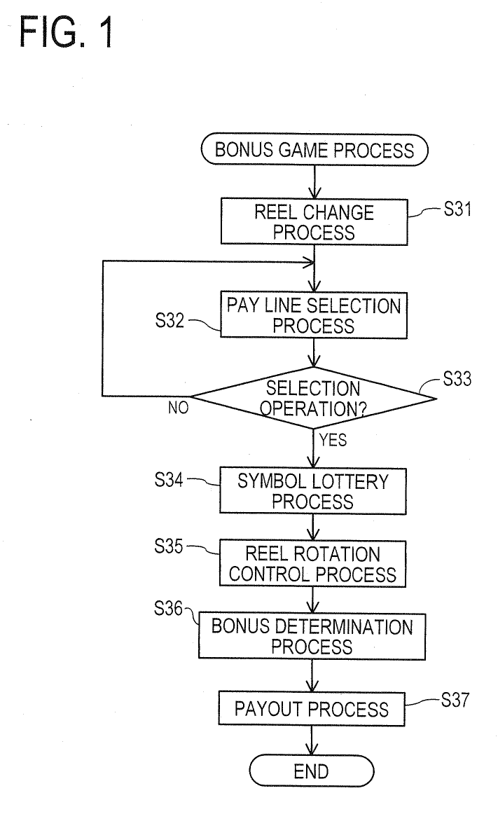

Next, a bonus game process program to be executed at the bonus game process (S20, S26) will be described in detail while referring to the drawings. FIG. 1 is a flow chart of a bonus game process program according to the present embodiment.

After shifting to the bonus game process (S20, S26), the main CPU 42 first executes the reel change process (S31) as shown in FIG. 1. In the reel change process (S31), the main CPU 42 changes the normal reel band 50 associated to the reel display portions to the bonus reel band 55. At this time, the main CPU 42 associates a table (refer to FIG. 19) including associations between the symbols and code numbers for the bonus reel band 55, to the reel display portions.

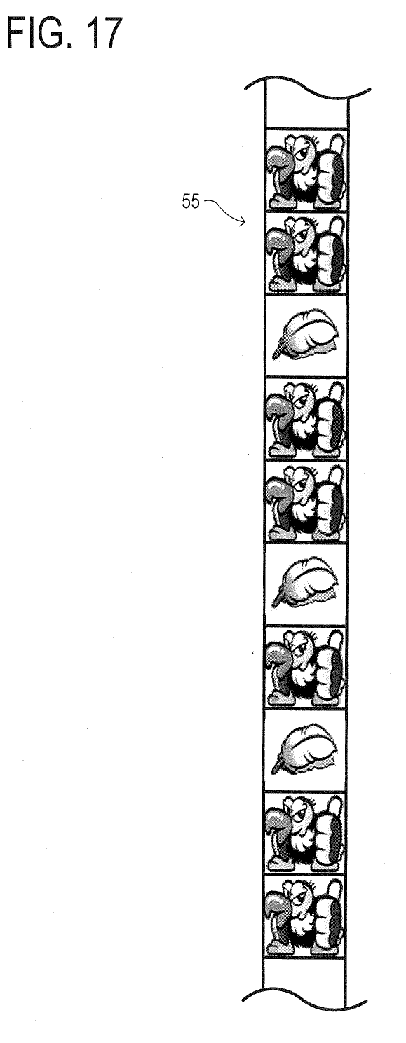

As shown in FIG. 17 and FIG. 19, the bonus reel band 55 includes only two types of symbols, including condor symbols 45B and feather symbols 45C arranged in an array. The symbol array in the bonus reel band 55 as shown in FIG. 17 and FIG. 19 is one example thereof, but other different types of arrays can be adopted.

In the reel change process (S31), once all the normal reel bands 50 for the reel display portions are changed to bonus reel band 55, the main CPU 42 first displays a bonus game screen (refer to FIG. 18) on the variable display portion 3B. Then, the main CPU 42 executes a pay line selection process (S32).

Here, the bonus game screen displayed on the variable display portion 3B will be described in detail while referring to the drawings.

In the bonus game, the reel display portions display one portion of the bonus reel band 55 (specifically, three symbols constituting the bonus reel band 55) associated to the reel display portions in the reel change process (S31).

As shown in FIG. 18, the bonus game screen displays “a message urging a player to select one pay line” and at the same time, a first pay line L1, a second pay line L2 and a third pay line L3 which are target for change. The first pay line L1 is made up of symbol display areas arranged at a central portion of the reel display portions (for instance, symbol display areas 111B, 112B, 113B, 114B and 115B). The second pay line L2 is made up of symbol display areas arranged at an upper portion of the reel display portions (specifically, symbol display areas 111A, 112A, 113A, 114A and 115A). The third pay line L3 is made up of symbol display areas arranged at a lower portion of the reel display portions (specifically, symbol display areas 111C, 112C, 113C, 114C and 115C).

At a left side of the first pay line L1 through the third pay line L3 are displayed a first pay line selection image 91, a second pay line selection image 92 and a third pay line selection image 93 in association with the pay lines. The first pay line selection image 91 shows choices for the first pay line L1. Similarly, the second pay line selection image 92 shows choices for the second pay line L2. The third pay line selection image 93 shows choices for the third pay line L3. The portion of the touch panel 4 corresponding to the first pay line selection image 91 through the third pay line selection image 93 is used in the selection operation of selecting one pay line from amongst the first pay line L1 through the third pay line L3.

Accordingly, in the pay line selection process (S32), the main CPU 42 displays the bonus game screen on the variable display portion 3B and accepts selection made by the player through the touch panel 4 with respect to the first pay line selection image 91 through the third pay line selection image 93. After the pay line selection process (S32), the main CPU 42 shifts the flow to process S33.

After shifting to S33, the main CPU 42 determines whether the selection operation of selecting one pay line from amongst the first pay line L1 through the third pay line L3 has been executed. More specifically, the main CPU 42 makes the determination at S33 based on an operation signal from the portion of the touch panel 4 corresponding to the first pay line selection image 91 through the third pay line selection image 93. If the pay line selection operation has been carried out (S33: YES), the main CPU 42 stores the pay line information showing the selected pay line in the RAM 43, and then shifts the flow to process S34. Alternatively, if the pay line selection operation has not yet been carried out (S33: NO), the main CPU 42 shifts the flow to process S32.

After shifting to S34, the main CPU 42 executes a symbol lottery process. In this symbol lottery process (S34), the main CPU 42 first samples one random number value from a predetermined range of random number values for each reel display portion. Then, the main CPU 42 identifies the code numbers in the reel display portions based on the random number value thus sampled and the table including associations between the random number values and the code numbers (for instance, refer to FIG. 15). Then, the main CPU 42 selects three symbols that will be displayed on the reel display portions in a stopped fashion based on the code numbers and the table (refer to FIG. 19) for the bonus reel band 55 associated to the reel display portions in the reel change process (S31). Once the symbol lottery process (S34) ends, the main CPU 42 shifts the process to S35.

At S35, the main CPU 42 executes a reel rotation control process. This reel rotation control process (S35) is similar to the above-described reel rotation control process (S14, S22) as described above, with the exception that a table (refer to FIG. 19) for the bonus reel band 55 and the bonus reel band 55 is used. Accordingly, a description of the reel rotation control process (S35) will be hereby omitted. Once the symbols determined in the symbol lottery process (S34) are displayed on the reel display portions in a stopped fashion, the main CPU 42 ends the reel rotation control process (S35) and shifts the process to S36.

At S36, the main CPU 42 executes a bonus contents determination process. In this bonus content determination process (S36), the main CPU 42 determines the contents of a bonus to be awarded to the player based on the number of condor symbols 45B displayed on the selected pay line in a stopped fashion and the bonus content determination table (refer to FIG. 20).

As was described earlier, the main CPU 42 can identify the symbols which are displayed on the symbol display areas in a stopped fashion by referencing the code numbers determined in the symbol lottery process (S34) and the table for the bonus reel band 55 (refer to FIG. 19). Accordingly, in the bonus content determination process (S36), the main CPU 42 can identify five symbols which are displayed on the selected pay line in a stopped fashion by reading out the pay line information stored in the pay line selection process (S32) from the RAM 43. The main CPU 42 determines the contents of the bonus to be awarded to the player based on the five symbols which are displayed on the selected pay line in a stopped fashion and the bonus content determination table.

Here, the bonus content determination table will be described while referring to FIG. 20. As shown in FIG. 20, in the bonus content determination table, bonus contents such as award of a MAJOR JACKPOT, award of a MINOR JACKPOT, award of 500 credits are associated to the number of condor symbols.

Accordingly, the main CPU 42 can determine the contents of one bonus to be awarded to the player from amongst three bonus contents by referencing the number of condor symbols 45B which are displayed on the selected pay line in a stopped fashion and the bonus content determination table. After determining the bonus contents to be awarded to the player, the main CPU 42 shifts the flow to process S37.

At S37, the main CPU 42 executes a payout process. In this payout process (S37), the main CPU 42 awards the bonus contents as determined in the bonus content determination process (S36) to the player. After the payout process (S37) ends, the main CPU 42 ends the bonus game process program.

As was described earlier, the slot machine 1 according to the present embodiment awards a bonus game to the player (S20, S26) if the bonus game trigger is established through the bonus “10” symbol 45P through bonus king symbol 45T (S19: YES, S25: YES).

In this bonus game, the slot machine 1 first accepts selection of the first pay line L1 through the third pay line L3 made by the player (S32). Specifically, the player can positively get involved in the bonus game by selecting the play line. As a result, the slot machine 1 can offer novel amusement to the player with respect to the bonus game.

The slot machine 1 determines, in the bonus game process (S20, S26), the contents of the bonus to be awarded to the player (any of award of the MAJOR JACKPOT, award of the MINOR JACKPOT and award of 500 credits), based on the number of condor symbols 45B which are displayed on the pay line selected by the player in a stopped fashion, and the bonus content determination table (refer to FIG. 20). Specifically, the slot machine 1 awards a bonus with contents that differ in accordance with the number of condor symbols 45B which are displayed on the selected pay line. Accordingly, the slot machine 1 can offer novel amusement to the player by raising the sense of expectancy with respect to award of a high payout in the bonus game. Further, the player can easily and clearly grasp the contents of the bonus to be awarded by looking at the symbols displayed on the pay line he/she selected.

The slot machine 1 has a plurality of progressive jackpots and awards, in the bonus game, a MAJOR JACKPOT or a MINOR JACKPOT in accordance with the number of condor symbols 45B which are displayed on the selected pay line in a stopped fashion. These progressive jackpots thus become much higher payouts than the payout awarded in the normal game (refer to FIG. 11 and FIG. 20). Accordingly, the slot machine 1 can further raise the sense of expectancy of the player hoping for award of a high payout.

The slot machine 1 changes, in the bonus game, the normal reel band 50 associated to the reel display portions to the bonus reel band 55 which is made of 2 types of symbols including the condor symbol 45B and the feather symbol 45C. As was described earlier, the slot machine 1 determines the bonus contents in accordance with the number condor symbols 45 displayed on the selected pay line in a stopped fashion. Accordingly, the player can easily judge whether or not the symbol is a condor symbol 45 by using the bonus reel band 55. The bonus reel band 55 includes a larger number of CONDOR symbols 45B than the normal reel band 50. Accordingly, the slot machine 1 can further raise the sense of expectancy of the player with respect to award of a bonus using the bonus reel band 55.

Further, the slot machine 1 carries out an all-scatter-type game as a normal game, wherein a prize is awarded in accordance with the number of the same kind of symbols displayed on the variable display portion 3B in a stopped fashion (refer to FIG. 11). Accordingly, the bonus game has game characteristics which clearly differ from the normal game. Specifically, what differs is selection of the pay line and determination of the prize based on the symbols displayed on the selected pay line. As a result, the slot machine 1 can help the player understand that the game shifted from the normal game to the bonus game based on the differences in game characteristics. The slot machine 1 can offer novel amusement with respect to the bonus game in the slot machine 1 due to the differences in the game characteristics.

The present invention is not limited to the present embodiment, but various improvements and modifications can be made thereto without departing from the scope of the present invention.

For instance, in the present embodiment, a description was given with respect to a so-called video slot machine. However, the slot machine can also include mechanical reels and a transparent liquid crystal display device having a variable display portion 3B arranged at a front face of the mechanical reels. Specifically, the slot machine 1 can be a so-called hybrid-type gaming machine. In this case, the pattern drawn on the mechanical reels is visible through the transparent liquid crystal display device.

In the hybrid-type slot machine, display of the symbols in a variable fashion and stopped fashion in the bonus game based on the bonus reel band 55 can be obtained by displaying the symbols in a scrolled fashion and stopped fashion in conjunction with the rotation of the stoppage of the mechanical reels in the transparent liquid crystal display device.

In the present embodiment, in the bonus game process (S20, S26), the slot machine 1 accepts a selection operation of selecting one pay line from three types of pay lines (first pay line L1 through third pay line L3). However, the embodiment is not limited to this aspect. For instance, the number of pay lines which are the target of selection can be increased or decreased. Also, a plurality of pay lines may also be selected in place of selecting one pay line.

The present invention can also be realized as a gaming method for executing the above-described processes. Further, the present invention can be realized as a program for causing a computer to execute the gaming method, and a recording medium onto which the program is recorded.

What is claimed is:

1. A gaming machine having:
a display that displays: a plurality of symbol display areas wherein plural types of symbols including a first symbol to which a high payout award is associated are displayed in a variable fashion, and one symbol is displayed in each of the plurality of symbol display areas in a stopped fashion; and symbols in a variable fashion and stopped fashion per a symbol row on which plural types of symbols including the first symbol are arranged; and
a processor that executes processes as follows:
(a) a process of executing a normal game wherein symbols are displayed on the display in a variable fashion and stopped fashion, based on the symbol row;
(b) a process of accepting a selection operation of selecting one pay line from a plurality of types of pay lines which are defined by the plurality of symbol display areas, if a game result of the normal game satisfies a predetermined condition;
(c) a process of starting a special game and displaying the symbols in a variable fashion and stopped fashion, on condition one pay line has been selected;
(d) a process of determining contents of one high payout from a plurality of high payouts having different contents, in accordance with the number of the first symbols displayed in a stopped fashion on symbol display areas making up the selected pay line; and
(e) a process of awarding said one high payout thus determined as a prize with respect to the special game.

2. The gaming machine according to claim 1, wherein the processor executes a process of changing the symbol row to be used in displaying the symbols in a variable fashion and stopped fashion into a special symbol row made up of the first symbol and a second symbol which differs from the first symbol, in a case where the game result of the normal game satisfies a predetermined condition.

3. The gaming machine according to claim 1, wherein the processor executes a process to determine contents of the prize in the normal game in accordance with the number of a same kind of symbols displayed on the display in a stopped state in the normal game.

4. The gaming machine according to claim 2, wherein the processor executes a process to determine contents of the prize in the normal game in accordance with the number of a same kind of symbols displayed on the display in a stopped state in the normal game.

5. A gaming machine having:
a display that displays: a plurality of symbol display areas wherein plural types of symbols including a first symbol to which a progressive payout award is associated are displayed in a variable fashion, and one symbol is displayed in each of the plurality of the symbol display areas in a stopped fashion; and symbols in a variable fashion and stopped fashion per a symbol row on which plural types of symbols including the first symbol are arranged; and
a processor that executes processes as follows:
(a) a process of executing a normal game wherein symbols are displayed on the display in a variable fashion and stopped fashion, based on the symbol row;
(b) a process of accepting a selection operation of selecting one pay line from a plurality of types of pay lines which are defined by the plurality of symbol display areas, if a game result of the normal game satisfies a predetermined condition;
(c) a process of starting a special game and displaying the symbols in a variable fashion and stopped fashion, on condition one pay line has been selected;
(d) a process of determining one progressive payout amount from a plurality of differing progressive payout amounts which are stored in a memory, in accordance with the number of the first symbols displayed in a stopped fashion on symbol display areas making up the selected pay line; and
(e) a process of acquiring information with respect to the progressive payout amount thus determined from the memory and awarding a progressive payout amount based on the information thus acquired as a prize with respect to the special game.

6. The gaming machine according to claim 5, wherein the processor executes a process of changing the symbol row to be used in displaying the symbols in a variable fashion and stopped fashion into a special symbol row made up of the first symbol and a second symbol which differs from the first symbol, in a case where the game result of the normal game satisfies a predetermined condition.

7. The gaming machine according to claim 5, wherein the processor executes a process to determine contents of the prize in the normal game in accordance with the number of a same kind of symbols displayed on the display in a stopped state in the normal game.

8. The gaming machine according to claim 6, wherein the processor executes a process to determine contents of the prize in the normal game in accordance with the number of a same kind of symbols displayed on the display in a stopped state in the normal game.

9. A gaming machine having:
a display that displays: a plurality of symbol display areas wherein plural types of symbols including a first symbol to which a progressive payout award is associated are displayed in a variable fashion, and one symbol is displayed in each of the plurality of the symbol display areas in a stopped fashion; and symbols in a variable fashion and stopped fashion per a video reel made up of symbol row on which plural types of symbols including the first symbol are arranged; and
a processor that executes processes as follows:
(a) a process of executing a normal game wherein symbols are displayed on the display in a variable fashion and stopped fashion, based on the video reels;
(b) a process of accepting a selection operation of selecting one pay line from a plurality of types of pay lines which are defined by the plurality of symbol display areas, if a game result of the normal game satisfies a predetermined condition;
(c) a process of starting a special game and displaying the symbols in a variable fashion and stopped fashion, on condition one pay line has been selected;
(d) a process of determining one progressive payout amount from a plurality of differing progressive payout amounts, in accordance with the number of the first symbols displayed in a stopped fashion on symbol display areas making up the selected pay line; and
(e) a process of acquiring information with respect to the progressive payout amount thus determined from a memory and awarding the progressive payout amount based on the acquired information as a prize with respect to the special game.

10. The gaming machine according to claim 9, wherein the processor executes a process of changing the symbol row to be used in displaying the symbols in a variable fashion and stopped fashion into a special symbol row made up of the first symbol and a second symbol which differs from the first symbol, in a case where the game result of the normal game satisfies a predetermined condition.

11. The gaming machine according to claim 10, wherein the processor executes a process to determine contents of the prize in the normal game in accordance with the number of a same kind of symbols displayed on the display in a stopped state in the normal game.

12. The gaming machine according to claim 10, wherein the processor executes a process to determine contents of the prize in the normal game in accordance with the number of a same kind of symbols displayed on the display in a stopped state in the normal game.
